(19) United States
(12) Patent Application Publication
(10) Pub. No.: US 2015/0288518 A1
(43) Pub. Date: Oct. 8, 2015

(54) ALGORITHM-AGNOSTIC APPROACH FOR SYSTEMATICALLY HARDENING ENCRYPTION

(71) Applicants: Karl P.W. Wiegand, Boston, MA (US); Angelique N. Wiegand, Seattle, WA (US)

(72) Inventors: Karl P.W. Wiegand, Boston, MA (US); Angelique N. Wiegand, Seattle, WA (US)

(21) Appl. No.: 14/247,959

(22) Filed: Apr. 8, 2014

(51) Int. Cl. H04L 9/08; G06F 21/60

(52) U.S. Cl. CPC H04L 9/0869; G06F 21/602; H04L 2209/24

(57) ABSTRACT

Embodiments are directed towards an encryption-agnostic approach to systematically hardening an encryption scheme. Plaintext, P, is received as a series of bits by a first computing device that may apply a transformation function f(C, H, Plaintext), where C and H are non-negative integer values, to the plaintext to generate hardened plaintext Q. The transformation function is directed towards selectively interleaving randomly generated bits through the series of bits in P based on values of C and H. Pre-pending or appending of randomly generated bits may be selectively turned on/off using input flags A and U. CH hardening parameters that include C and H, and flags A and U may be combined with the hardened plaintext Q. The combination may then be encrypted using any of a variety of encryption schemes. A reverse process is employed to obtain the CH parameters, which are used to extract the plaintext from Q.

### TECHNICAL FIELD

The present invention relates generally to computing security and, more particularly, to providing a systematic approach to hardening any symmetric or asymmetric encryption mechanism.

### BACKGROUND

Almost wherever one reads, there is something about hacking into a person's or business's computing system to steal confidential information. There are a large number of entities, legitimate and not so legitimate, that thrive on accessing electronic communications to learn more about consumers. In an effort to stem the tide of information theft, consumers often turn to increasing their use of security, such as encryption; however, various business or technological constraints often result in the selection of lower quality encryption techniques. For example, in order to be able to quickly send messages on a limited computing device, such as a mobile phone, the encryption implemented may be selected not on how strong it is, but rather based on how fast it operates, or how little memory it consumes. Thus, while consumers may be led to believe that their communications are safe because they are encrypted, they may not be. Therefore, there is a desire to seek approaches that are directed towards hardening or otherwise strengthening the encryption used to secure information. It is with respect to these considerations and others that the invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 illustrates a system environment in which various embodiments may be implemented;

FIG. 2 shows one embodiment of a client device that may be included in various embodiments;

FIG. 3 illustrates one embodiment of a network device that may be included in various embodiments;

FIG. 4 illustrates one embodiment of a process diagram usable in employing an algorithm-agnostic approach for hardening encryption;

FIG. 5 illustrates one embodiment of a process diagram usable to harden encryption of plaintext by adding entropy to plaintext;

FIG. 6 illustrates one embodiment of a process diagram usable to remove entropy from hardened plaintext; and

FIG. 7 illustrates one non-limiting, non-exhaustive example output using the process of FIG. 5.

### DETAILED DESCRIPTION

Various embodiments will now be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

As used herein, the term “plaintext” refers to any ‘normal’ representation of information content before any action has been taken to conceal the information by applying a form of encryption upon the information content. Plaintext is sometimes referred to as “cleartext.” Plaintext is used as input to an encryption algorithm; the output of the encryption algorithm is usually termed ciphertext. Further, plaintext includes any information content that may be represented as a string of bits, whether the content is formatted, unformatted, styled, or rich content. As such, plaintext as used herein includes formatted document files, markup language files, and so forth, as well as binary files, compressed files, and so forth. Thus, plaintext may also include image files, streaming files, application files, and so forth.

In some embodiments, it should be noted that embodiments disclosed herein may also be applied to encrypted content. For example, in some embodiments, the input ‘plaintext’ to the disclosed hardening approach may be ciphertext.

As used herein, the term “random” refers to a sequence of bits that appear to lack any pattern over some period of time. As such, the term random, as used herein, includes a pseudo-random sequence of bits.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes embodiments in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed towards an encryption-agnostic approach to systematically hardening any symmetric or asymmetric encryption scheme. Given a series of bits to encrypt, herein referred to as plaintext, a systematic/interleaving of padding bits is performed on the plaintext with randomly generated bits to add entropy to the plaintext and thereby harden the input to an encryption algorithm. That is, plaintext, P, is received as a series of bits. A first computing device may apply a transformation function f(C, H, Plaintext), where C and H are non-negative integer values, to the plaintext to generate hardened plaintext Q that includes increased entropy over that of the plaintext. The transformation function is directed towards selectively interleaving randomly generated bits through the series of bits in P based on values of C and H. In some embodiments, pre-pending or appending of randomly generated bits may be selectively turned on/off using input flags A and U. CH hardening parameters that include C and H, and flags A and U may be combined with the hardened plaintext Q. In one embodiment, the CH hardening parameters may be included as a header to the hardened plaintext Q. However, the CH hardening parameters may also be included as a footer or within some other specified field with the hardened plaintext Q. The resulting hardened plaintext Q (including the CH hardening parameters) may then be submitted to any of a variety of encryption algorithms to generate ciphertext.

The ciphertext may then be stored for later use, or be communicated from the first computing device to a second computing device, which may decrypt the ciphertext, extract the CH hardening parameters, and employ the CH hardening parameters to then remove the added entropy to generate the original plaintext.

As may be seen, the disclosed hardening approach may employ any encryption approach, and is directed to strengthen (or otherwise harden) the encryption used. As such, a differential analysis of the ciphertext is intended to become arbitrarily harder at the expense of the output size, assuming the encryption approach used leverages the avalanche effect (e.g., via distribution/diffusion or the like). The disclosed approach specifies an initialization vector (IV) or nonce, but does not require publicizing the IV/nonce. Instead of describing or specifying the IV/nonce, a mechanism is provided for locating and removing the IV/nonce from the decrypted bits. The disclosed approach works on any encryption approach other than one-way hashing techniques, as a pre-hardening. Further, the disclosed approach can be used even where the plaintext is fairly short in terms of the number of bits, obscuring the amount of information being transmitted by increasing the values for C and H compared to the length of the plaintext.

### Illustrative Operating Environment

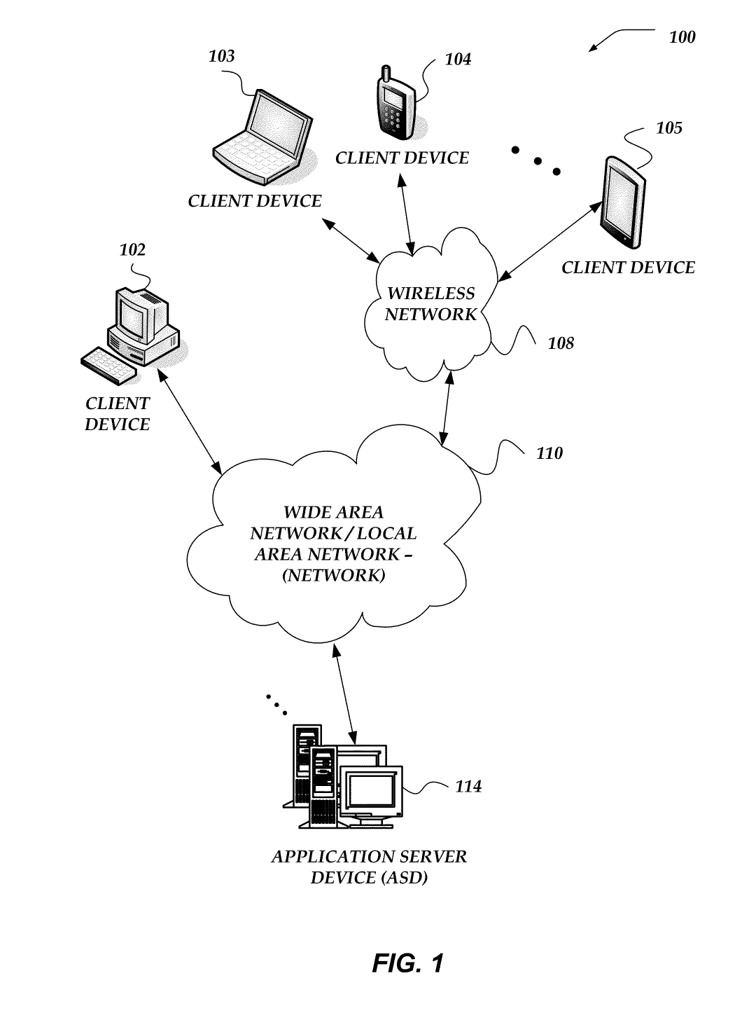

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)-(network) 110, wireless network 108, client devices 102-105, and Application Server Device (ASD) 114.

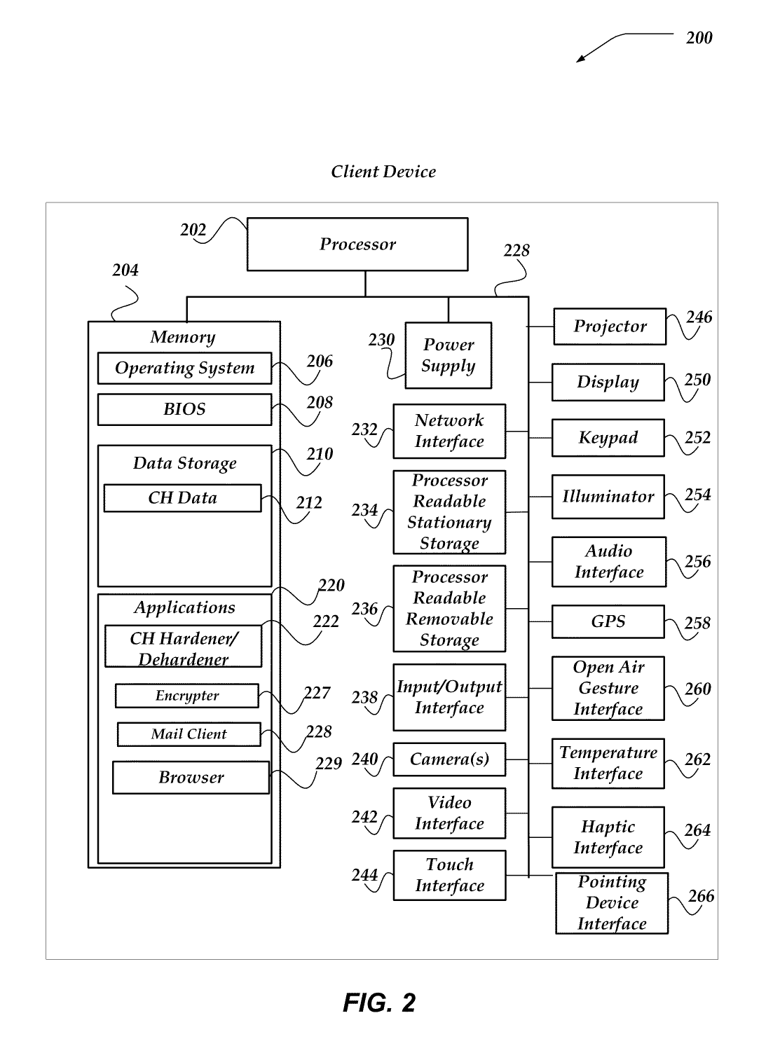

At least one embodiment of client devices 102-105 is described in more detail below in conjunction with FIG. 2. Generally however, client devices 102-105 may include virtually any computing device capable of communicating over a network (wireless and/or wired) to send and receive information, perform various online (network) activities, offline actions, or the like. In one embodiment, one or more of client devices 102-105 may be configured to operate within a business or other entity to perform a variety of services for the business or other entity. For example, client devices 102-105 may be configured to operate as a web server, an accounting server, a production server, an inventory server, or the like. However, client devices 102-105 are not constrained to these services and may also be employed, for example, as an end-user computing node, in other embodiments. It should be recognized that more or less client devices may be included within a system such as described herein, and embodiments are therefore not constrained by the number or type of client devices employed.

Devices that may operate as client device 102 may include devices that typically connect using a wired or wireless communications medium such as personal computers, multiprocessor systems, microprocessor-based or programmable electronic devices, network PCs, or the like. In some embodiments, client devices 102-105 may include virtually any portable personal computing device capable of connecting to another computing device and receiving information such as, laptop computer 103, smart mobile telephone 104, and tablet computers 105, and the like. However, portable computing devices are not so limited and may also include other portable devices such as cellular telephones, display pagers, radio frequency (RF) devices, infrared (IR) devices, Personal Digital Assistants (PDAs), handheld computers, wearable computers, integrated devices combining one or more of the preceding devices, and the like. As such, client devices 102-105 typically range widely in terms of capabilities and features. Moreover, client devices 102-105 may access various computing applications, including a browser, or other web-based application.

A web-enabled client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), and the like, to display and send a message. In one embodiment, a user of the client device may employ the browser application to perform various activities over a network (online). However, another application may also be used to perform various online activities.

Client devices 102-105 also may include at least one other client application that is configured to receive and/or send content between another computing device. The client application may include a capability to send and/or receive content, or the like. The client application may further provide information that identifies itself, including a type, capability, name, and the like. In one embodiment, client devices 102-105 may uniquely identify themselves through any of a variety of mechanisms, including an Internet Protocol (IP) address, a phone number, Mobile Identification Number (MIN), an electronic serial number (ESN), or other device identifier. Such information may be provided in a network packet, or the like, sent between other client devices, Application Server Device (ASD) 114, or other computing devices.

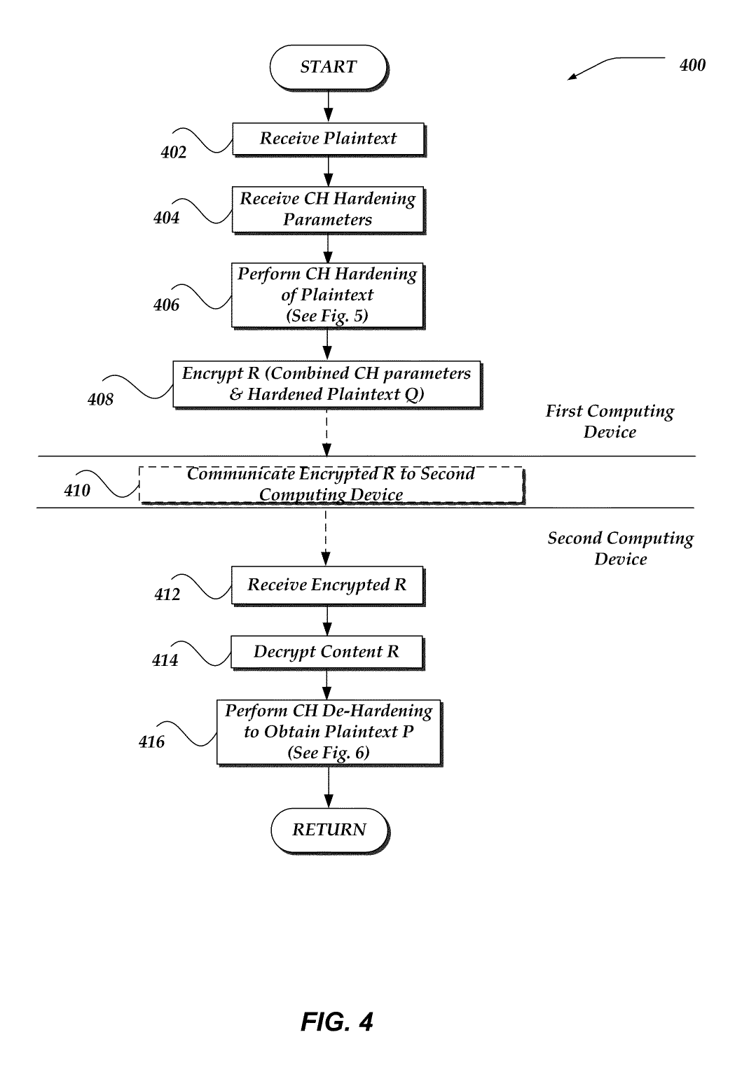

Client devices 102-105 may further be configured to include a client application, such as a browser, email client, or the like, that enables an end-user to log into an end-user account that may be managed by another computing device, such as ASD 114, or the like. Such end-user account, in one non-limiting example, may be configured to enable the end-user to manage a variety of information, including, but not limited to email, web based services, file transfer (e.g., FTP) services, video content streaming services, and the like. In some embodiments, the communications between computing devices may employ an algorithm-agnostic approach for systematically hardening encryption of plaintext, as described further below in at least FIGS. 4-6.

Wireless network 108 is configured to couple client devices 103-105 and its components with network 110. Wireless network 108 may include any of a variety of wireless sub-networks that may further overlay stand-alone ad-hoc networks, and the like, to provide an infrastructure-oriented connection for client devices 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile devices, such as client devices 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client devices 103-105 and another computing device, network, and the like.

Network 110 is configured to couple network devices with other computing devices, including, ASD 114, client device 102, and client devices 103-105 through wireless network 108. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP). In essence, network 110 includes any communication method by which information may travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. It should be noted that communication media as disclosed herein refers to physical, non-transitory devices, rather than the transitory content communicated over such devices.

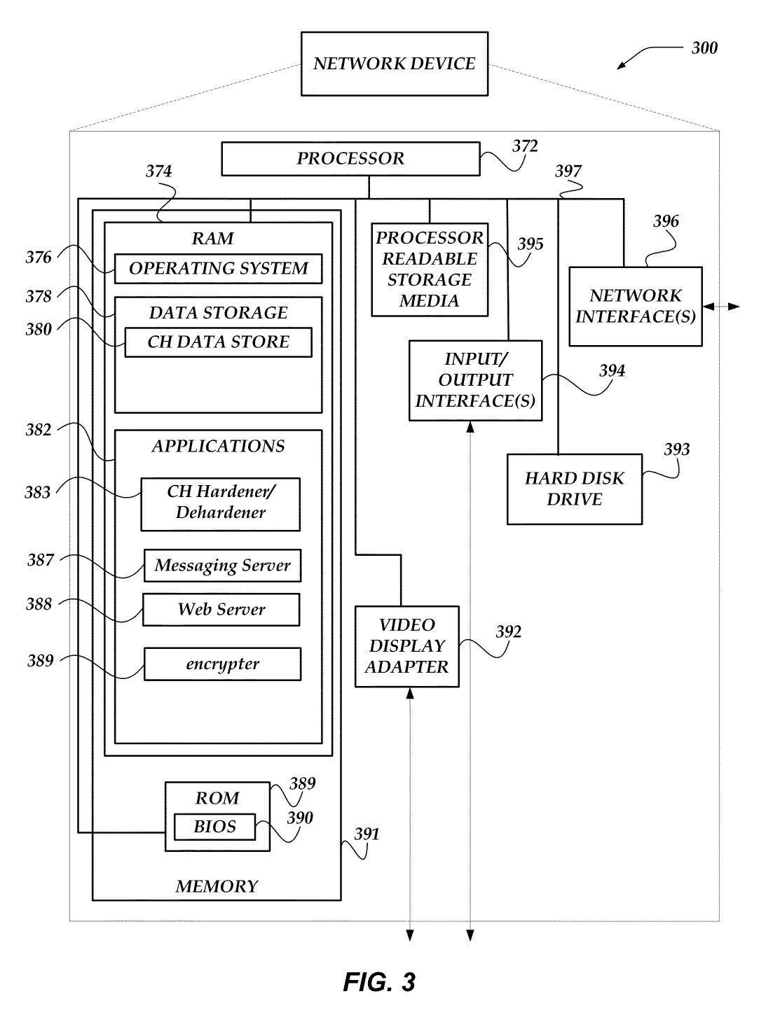

One embodiment of Application Server Device (ASD) 114 is described in more detail below in conjunction with FIG. 3. Briefly, however, ASD 114 includes virtually any network device capable of providing third-party services and/or information items, to users of client devices 102-105. ASD 114 may include, but is not limited to, personal information manager services, web-based email services, storage services, text messaging, calendar services, video streaming services, document management services, social media services, or the like. Moreover, in one embodiment, ASD 114 may also employ an algorithm-agnostic approach for systematically hardening encryption of plaintext, as described further below.

Devices that may be arranged to operate as ASD 114 include various network devices, including, but not limited to personal computers, desktop computers, multiprocessor systems, microprocessor-based or programmable consumer electronics, network PCs, server devices, network appliances, and the like.

Although FIG. 1 illustrates ASD 114 as a single computing device, other embodiments are not so limited. For example, one or more functions of the ASD 114 may be distributed across one or more distinct network devices. Moreover, ASD 114 is not limited to a particular configuration. Thus, in one embodiment, ASD 114 may contain a plurality of network devices. In another embodiment, ASD 114 may contain a plurality of network devices that operate using a master/slave approach, where one of the plurality of network devices of ASD 114 operates to manage and/or otherwise coordinate operations of the other network devices. In other embodiments, the ASD 114 may operate as a plurality of network devices within a cluster architecture, a peer-to-peer architecture, and/or even within a cloud architecture. Thus, the invention is not to be construed as being limited to a single environment, and other configurations, and architectures are also envisaged.

### Illustrative Client Device

FIG. 2 shows one embodiment of client device 200 that may include many more or less components than those shown. However, those components shown are sufficient to disclose at least one embodiment of the invention. Client device 200 may represent, for example, at least one embodiment of client devices shown in FIG. 1.

Client device 200 may include one or more processor (central processing unit or CPU) 202 in communications with memory 204 via bus 228. Client device 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client device 200 may optionally communicate with a base station (not shown), or directly with another computing device. Further, in one embodiment, although not shown, a gyroscope may be employed within client device 200 for measuring and/or maintaining an orientation of client device 200. Also not shown, one or more accelerometers may be employed within client device 200 to measure the acceleration and/or orientation of client device 200.

Power supply 230 may provide power to client device 200. A rechargeable or non-rechargeable battery may be used to provide power. The power may also be provided by an external power source, such as an AC adapter or a powered docking cradle that supplements and/or recharges the battery.

Network interface 232 includes circuitry for coupling client device 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of client device 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computing device. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to events. For example, when illuminator 254 is active, it may backlight the buttons on keypad 252 and stay on while the client device is powered. Also, illuminator 254 may backlight these buttons in various patterns when particular actions are performed, such as dialing another client device. Illuminator 254 may also cause light sources positioned within a transparent or translucent case of the client device to illuminate in response to actions.

Client device 200 may also comprise input/output interface 238 for communicating with external peripheral devices or other computing devices such as other client devices and network devices. The peripheral devices may include an audio headset, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Haptic interface 264 may be arranged to provide tactile feedback to a user of the client device. For example, the haptic interface 264 may be employed to vibrate client device 200 in a particular way when another user of a computing device is calling. Temperature interface 262 may be used to provide a temperature measurement input and/or a temperature changing output to a user of client device 200. Open air gesture interface 260 may sense physical gestures of a user of client device 200, for example, by using single or stereo video cameras, radar, a gyroscopic sensor inside a device held or worn by the user, or the like. Camera 240 may be used to track physical eye movements of a user of client device 200.

GPS transceiver 258 can determine the physical coordinates of client device 100 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client device 200 on the surface of the Earth. It is understood that under different conditions, GPS transceiver 258 can determine a physical location for client device 200. In at least one embodiment, however, client device 200 may, through other components, provide other information that may be employed to determine a physical location of the device, including for example, a Media Access Control (MAC) address, IP address, and the like.

Human interface components can be peripheral devices that are physically separate from client device 200, allowing for remote input and/or output to client device 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client device with such peripheral human interface components is a wearable computing device, which might include a remote pico projector along with one or more cameras that remotely communicate with a separately located client device to sense a user's gestures toward portions of an image projected by the pico projector onto a reflected surface such as a wall or the user's hand.

Memory 204 may include RAM, ROM, and/or other types of memory. Memory 204 illustrates an example of computer-readable storage media (devices) for storage of information such as computer-readable instructions, data structures, program modules or other data. Memory 204 may store BIOS 208 for controlling low-level operation of client device 200. The memory may also store operating system 206 for controlling the operation of client device 200. It will be appreciated that this component may include a general-purpose operating system such as a version of UNIX, or LINUX™, or a specialized mobile computer communication operating system such as iOS™, Android™, Windows Phone™, or the Symbian® operating system. The operating system may include, or interface with a Java virtual machine module that enables control of hardware components and/or operating system operations via Java application programs.

Memory 204 may further include one or more data storage 210, which can be utilized by client device 200 to store, among other things, applications 220 and/or other data. For example, data storage 210 may also be employed to store information that describes various capabilities of client device 200. The information may then be provided to another device based on any of a variety of events, including being sent as part of a header during a communication, sent upon request, or the like. Data storage 210 may also be employed to store information including address books, buddy lists, aliases, user profile information, contacts, notes, events, folders, or the like. Data storage 210 may further include program code, data, algorithms, and the like, for use by a processor, such as processor 202 to execute and perform actions. Data storage 210 may also include CH data 212 which is configured to store and/or otherwise manage data, including CH hardening parameters, various buffers such as described in more detail below, as well as other data usable by CH hardener/dehardener 222. In one embodiment, at least some of data storage 210 might also be stored on another component of client device 200, including, but not limited to, non-transitory (computer) processor-readable removable storage device 236, processor-readable stationary storage device 234, or even external to the client device.

Applications 220 may include computer executable instructions which, when executed by client device 200, transmit, receive, and/or otherwise process instructions and data. Applications 220 may include, for example, calendars, search programs, IM applications, SMS applications, Voice Over Internet Protocol (VOIP) applications, contact managers, task managers, transcoders, database programs, word processing programs, security applications, spreadsheet programs, games, search programs, and so forth.

Applications 220 may include browser 229 that is configured to receive and to send web pages, web-based messages, graphics, text, multimedia, and the like. The client device's browser 229 may employ virtually any programming language, including a wireless application protocol messages (WAP), and the like. In at least one embodiment, browser 229 is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Applications 220 may also include one or more mail clients 228 that is configured to receive and to send messages using any of a variety of messaging protocols, including, but not limited to SMTP protocol (Simple Mail Transfer Protocol), POP protocol (Post Office Protocol), IMAP protocol (Internet Message Access Protocol), or so forth. However, mail clients 228 may also employ a variety of other messaging protocols, including but not limited to instant messaging protocols, Real Time Messaging Protocol (RTMP), and so forth.

Applications may further include encrypter (decrypter) 227 which represents any of a variety of encryption applications including symmetric algorithms and asymmetric algorithms. CH hardener/dehardener (CHD) 222 may also be included in applications 220. Briefly, CHD 222 is configured as computer-executable instructions that when executed within processor 202, is arranged to provide an algorithm-agnostic approach to systematically hardening any symmetric or asymmetric encryption scheme. CHD 222 is configured to receive plaintext P, and to systematically interleave randomly generated padding bits with the plaintext to add entropy to the plaintext, thereby generating hardened plaintext output Q. CHD 22 may perform such actions using various CH hardening parameters, which may be further combined with the output Q, which may be provided to encrypter 227 for encryption. A similar process (but in reverse) may be applied by CHD 222 to retrieve plaintext from previous CH hardened plaintext. CHD 222 may employ processes such as those described below in more detail in conjunction with FIGS. 4-6.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may be configured to operate as a server, client, peer, a host, or any other device. Network device 300 may represent, for example ASD 114 of FIG. 1, and/or other network devices.

Network device 300 includes processor 374, processor readable storage media 395, network interface unit 396, an input/output interface 394, hard disk drive 393, video display adapter 392, and memory 391, all in communication with each other via bus 397. In some embodiments, processor 372 may include one or more central processing units.

As illustrated in FIG. 3, network device 300 also can communicate with the Internet, or some other communications network, via network interface unit 396, which is constructed for use with various communication protocols including the TCP/IP protocol. Network interface unit 396 is sometimes known as a transceiver, transceiving device, or network interface card (NIC).

Network device 300 also comprises input/output interface 394 for communicating with external devices, such as a keyboard, or other input or output devices not shown in FIG. 3. Input/output interface 394 can utilize one or more communication technologies, such as USB, infrared, Bluetooth™, or the like.

Memory 391 generally includes RAM 374, ROM 389 and one or more permanent mass storage devices, such as hard disk drive 393, tape drive, optical drive, and/or floppy disk drive. Memory 391 stores operating system 376 for controlling the operation of network device 300. Any general-purpose operating system may be employed. Basic input/output system (BIOS) 390 is also provided for controlling the low-level operation of network device 300.

Although illustrated separately, memory 391 may include processor readable storage media 395. Processor readable storage media 395 may be referred to and/or include computer readable media, computer readable storage media, and/or processor readable storage device. Processor readable storage media 395 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computing device. Moreover, each of the herein mentioned memory and other storage components are physical devices, and as such are non-transitory devices.

Memory 391 further includes one or more data storage 378, which can be utilized by network device 300 to store, among other things, applications 382 and/or other data. For example, data storage 378 may also be employed to store information that describes various capabilities of network device 300. The information may then be provided to another device based on any of a variety of events, including being sent as part of a header during a communication, sent upon request, or the like. Data storage 378 may also be employed to store messages, web page content, or the like. At least a portion of the information may also be stored on another component of network device 300, including, but not limited to processor readable storage media 395, hard disk drive 393, or other computer readable storage medias (not shown) within client device 300.

Data storage 378 may include a database, text, spreadsheet, folder, file, or the like, that may be configured to maintain and store user account identifiers, user profiles, email addresses, IM addresses, and/or other network addresses; or the like. Data storage 378 may further include program code, data, algorithms, and the like, for use by a processor, such as processor 372 to execute and perform actions. In one embodiment, at least some of data store 378 might also be stored on another component of network device 300, including, but not limited to processor-readable storage media 395, hard disk drive 393, or the like.

Data storage 378 may include CH data store 380. CH data store 380 may include various buffers, CH hardening parameters, and other data usable by CH hardener/dehardener (CHD) 383 described in more detail below.

In a manner somewhat similar to applications 220 that may reside on client device 200, applications 382 may include computer executable instructions which, when executed by network device 300, transmit, receive, and/or otherwise process instructions and data. Applications 382 may include, for example, web server 388, calendars, search programs, messaging server 387, IM applications, SMS applications, Voice Over Internet Protocol (VOIP) applications, contact managers, task managers, transcoders, database programs, word processing programs, security applications, spreadsheet programs, games, search programs, and so forth. Applications 382 may also include CHD 383, which is configured to perform actions somewhat similar to CHD 222 of FIG. 2, including employing encrypter 389 to encrypt and/or decrypt data.

### Generalized Operation

The operation of certain aspects of the invention will now be described with respect to FIGS. 4-6. The processes described below with respect to FIGS. 4-6 may be performed within any of a variety of computing devices having one or more processors. For example, the processes of FIGS. 4-6 may be performed by client devices 102-106 of FIG. 1, ASD 114 of FIG. 1, client device 200 of FIG. 2, and/or network device 300 of FIG. 3.

FIG. 4 illustrates one embodiment of a process diagram 400 usable in employing an algorithm-agnostic approach for hardening encryption. As illustrated in FIG. 4, process 400 may be partitioned into at least two portions, where a first portion is performed by a first computing device, and a second portion is performed by a second computing device. In one embodiment, the output of the first portion of process 400 may be communicated to the second computing device using any of a variety of mechanisms, including but not limited to over a network, via a computer-readable storage medium such as a disk, tape, memory stick, or the like. The mechanism used to communicate the output to the second computing device is not construed as limiting. Moreover, while process 400 illustrates a first and second computing device, in at least some embodiments, the first and second computing device may be the same computing device. Thus, for example, plaintext may be processed using CH hardening, encrypted, and stored for later access. The stored data may subsequently be retrieved and processed to retrieve the plaintext within the same first computing device.

In any event, process 400 begins, after a start block, at block 402, where plaintext P is received. As discussed above, plaintext P may represent any of a variety of data. In one embodiment, however, plaintext P is received as a series of bits. That is,

Pε{0,1}ⁿ, where n≧0.

Moving to block 404, CH hardening parameters are received. The CH hardening parameters may received through any of a variety of mechanisms, including through a user input device, as default values, over a network, from another application, or virtually any other approach. The CH hardening parameters include, but are not limited to:

C: a maximum length of contiguous untouched plaintext bits;

H: a minimum length of contiguous random bits (from any of a variety of entropy sources);

A: a flag, bit, or other indicator instructing the process whether to start with randomness; and

U: a flag, bit, or other indicator instructing the process whether to end with randomness; where

C,Hε [symbol] ∪{0}

A,Uε{0,1}

It should be noted that other parameters may also be included for some embodiments, such as described further below.

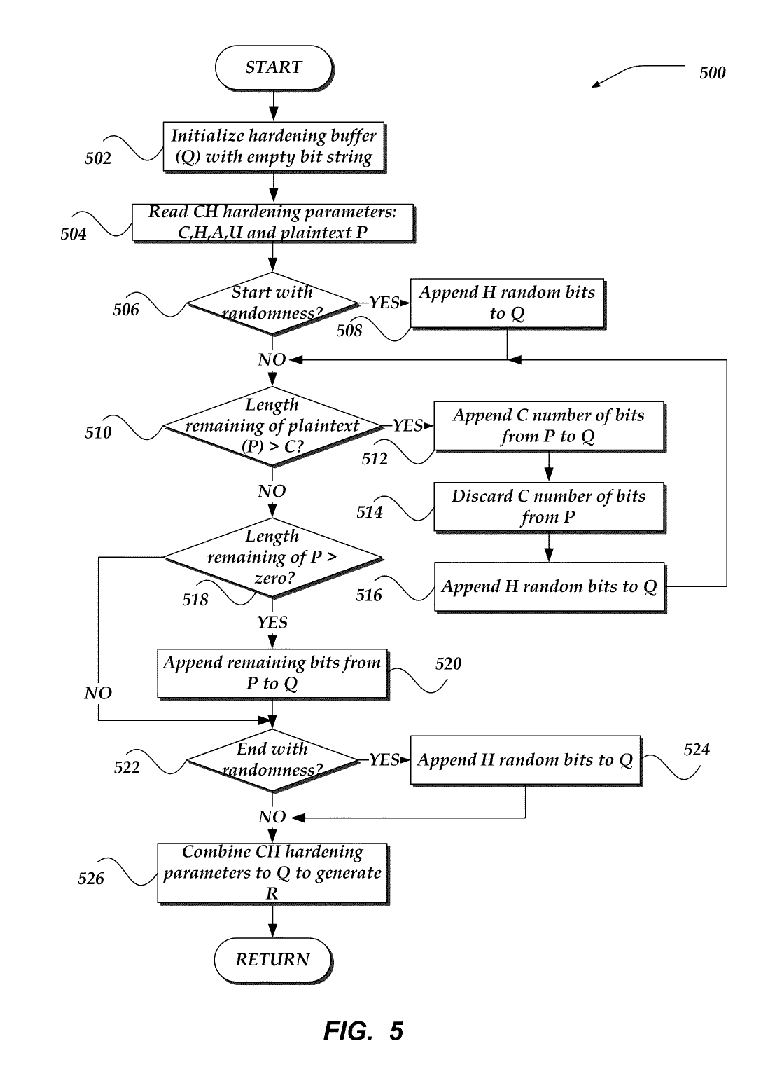

Processing 400 then flows to block 406, which is described in more detail below in conjunction with FIG. 5. Briefly, however, at block 406, the CH hardening parameters are used to harden the received plaintext P by adding entropy to the plaintext, and then combining the hardened plaintext with the CH hardening parameters. The output R of block 406 is a combination of the CH hardening parameters with the hardened plaintext Q.

Flowing next to block 408, any of a variety of two-way encryption algorithms (as opposed to one-way encryption, such as one-way hashes) is employed to generate a ciphertext. That is, for any encryption algorithm, ε(R):

ε_{H}(R)=ε(C, H, A, U, f(P, C, H, A, U)), where f(P, C, H, A, U) represents the hardened plaintext, Q.

As shown in process 400, at block 410, the encrypted result may be communicated to a second computing device using any of a variety of mechanisms, including over a network, via a portable non-transitory computer-readable storage device, or the like. As noted, block 410 may be considered as an optional step, in that the process does not require communication to a second computing device. For example, the first computing device may elect to store the encrypted R (ciphertext) locally or remotely for subsequent use. In such non-limiting example, the second computing device mentioned in FIG. 4 might then be the same first computing device.

The blocks illustrated in FIG. 4 after block 410 then represent actions performed on the ciphertext to extract the plaintext P. As shown then, at block 412, the ciphertext (encrypted R) is received, from over a network, or from another source. Moving to block 414, the ciphertext is then decrypted using a decryption algorithm associated with the encryption algorithm used at block 408.

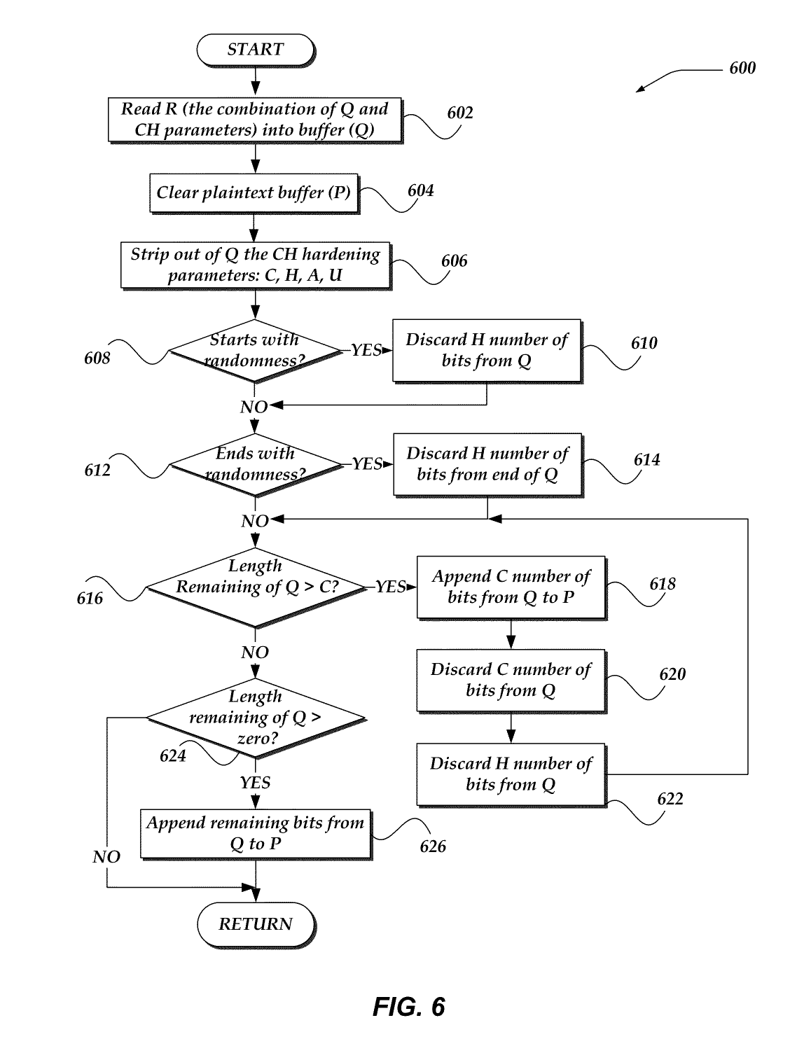

Continuing to block 416, the decrypted content R (combination of the CH parameters and Q) is then de-hardened to obtain the original plaintext P. One embodiment of a process usable in block 416 is described in more detail below in conjunction with FIG. 6. The output of block 416 is then the original plaintext P, which may then be viewed or otherwise employed. Process 400 may then return to a calling process.

FIG. 5 illustrates one embodiment of a process diagram usable to harden encryption of plaintext by adding entropy to plaintext. Process 500 of FIG. 5 may represent one embodiment of a process usable within block 406 of FIG. 4.

Process 500 begins, after a start block, at block 502, where a hardening buffer (Q) is initialized with an empty bit string. Processing then proceeds to block 504, where the CH hardening parameters, C, H, A, U, and the plaintext P are read or otherwise received for use by process 500.

Continuing next to decision block 506, a determination is made whether to start with randomness, as indicated by a value of A in the CH parameters. For example, a zero value might indicate not to start with randomness, while a non-zero value might indicate to start with randomness. Other values, or indicators, may also be used. In any event, if the process is to start with randomness, then processing flows to block 508; otherwise processing continues to decision block 510.

At block 508, H random bits may be appended to the content in the buffer Q. Processing then flows to decision block 510.

At decision block 510, a determination is made whether the length of the remaining of plaintext P is greater than C (in the CH hardening parameters). A seen further below, the length of plaintext P may vary as process 500 is executed. Thus, in a first ‘loop,’ the length of P is an original length when P is read at block 504. If the length remaining of P is greater than C, then processing flows to block 512; otherwise processing flows to decision block 518.

At block 512, C bits from P are appended to the contents in the buffer Q. Process 500 then flows to block 514, where C bits are discarded from P. That is, a same number of bits appended to Q from P are now removed from P, which shortens the length of P. Continuing to block 516, H random bits are then appended to the content in buffer Q. Processing then flows back to decision block 510 until the length remaining of P is no longer greater than C.

At decision block 518, a determination is made whether the length of the remaining plaintext P is greater than zero. If so, then processing flows to block 520; otherwise, processing branches to decision block 522.

At block 520, the remaining bits comprising P are appended to the contents of buffer Q. Processing then continues to decision block 522.

At decision block 522, a determination is made whether to end the hardening of P with additional randomness. In one embodiment, a value of U in the CH hardening parameters may indicate whether to include additional randomness. If not, then processing flows to block 526. If so, then processing flows to block 524, where H random bits are appended to the contents of buffer Q. The contents of buffer Q represent the hardened plaintext P (or, simply Q). Processing continues next to block 526.

At block 526, the CH hardening parameters are then combined with Q to generate the hardened output R. The CH hardening parameters may be combined using any of variety of approaches. For example, the CH hardening parameters may be combined by appending them to Q. In some embodiments, the CH hardening parameters may be combined by pre-pending them to Q. In some embodiments, predefined separators, such as commas, or the like may be used to designate separations between the parameters. However, in other embodiments, the parameters may be pre-defined to be a certain number of bits. For example, C and H may be represented by bit strings of three bits, four bits, or the like. Thus, in one non-limiting example, C=5 might be represented as C=101. Similarly, A and U might be pre-defined as one bit in length each. Thus, for the case of C=5, H=2, and A and U each being equal to 1, the CH parameters combined with Q might be:
10101011

It should be understood that the above represents non-limiting examples, and other approaches may also be used. By combining the CH hardening parameters with Q, there is also no need to provide the CH hardening parameters using, for example, an ‘out-of-band’ process from how the ciphertext is communicated. In any event, the CH hardening parameters may then be pre-pended or appended to Q providing for further obfuscation of information. Process 500 then returns, providing as output, R.

FIG. 6 illustrates one embodiment of a process diagram usable to remove entropy from the hardened plaintext. Process 600 of FIG. 6 may represent one embodiment of a process usable at block 416 of FIG. 4.

Process 600 begins, after a start block, at block 602, where R, the combination of Q and the CH hardening parameters are read into buffer Q. Processing then flows to block 604, where a plaintext buffer (P) is cleared or otherwise made empty.

Continuing next to block 606, based on a pre-defined configuration, the CH hardening parameters (de-hardening parameters as used in process 600) are stripped from the content of the buffer Q, leaving the hardened plaintext P.

Process 600 flows next to decision block 608, where a determination is made whether the hardened plaintext P started with randomness, as indicated by a value of A in the CH hardening parameters. If not, then processing flows to decision block 612. If so, then processing continues to block 610, where H bits from a beginning location in buffer Q are removed from the contents of buffer Q. Processing then flows to decision block 612.

At decision block 612, a determination is made whether the hardened plaintext P ended with randomness. If not, then processing continues to decision block 616; otherwise, processing flows to block 614, where H bits are removed from an ending location (other side of the beginning location) in buffer Q. Processing continues to decision block 616.

At decision block 616, a determination is made whether a remaining length of the contents of the buffer Q are greater than C. If not, then processing continues to decision block 624; otherwise, processing flows to block 618.

At block 618, C bits from the contents of buffer Q are appended to the contents of the buffer P. Processing continues to block 620, where C bits are discarded from the contents of the buffer Q (the same bits appended to the contents of the buffer P). Continuing to block 622, H bits are discarded from the content of the buffer Q. Processing then branches back to decision block 616 until the remaining length of the content of buffer Q is no longer greater than C.

At decision block 624, a determination is made whether the remaining length of the contents of the buffer Q is greater than zero. If not, then process 600 returns to a calling process. If so, however, the remaining bits from the buffer Q are appended to the contents of the buffer P. Processing then returns to the calling process, where the output of process 600 is the plaintext P (contents of buffer P).

It will be understood that figures, and combinations of steps in the flow diagram-like illustrations, can be implemented by computer program instructions. These program instructions may be provided to a processor to produce a machine, such that the instructions, which execute on the processor, create means for implementing the actions specified in the flow diagram block or blocks. The computer program instructions may be executed by a processor to cause a series of operational steps to be performed by the processor to produce a computer implemented process such that the instructions, which execute on the processor to provide steps for implementing the actions specified in the flow diagram block or blocks. These program instructions may be stored on a computer readable medium or machine readable medium, such as a computer readable storage medium.

Accordingly, the illustrations support combinations of means for performing the specified actions, combinations of steps for performing the specified actions and program instruction means for performing the specified actions. It will also be understood that each block of the flow diagram illustration, and combinations of blocks in the flow diagram illustration, can be implemented by modules such as special purpose hardware-based systems which perform the specified actions or steps, or combinations of special purpose hardware and computer instructions.

### Non-Limiting, Non-Exhaustive Example

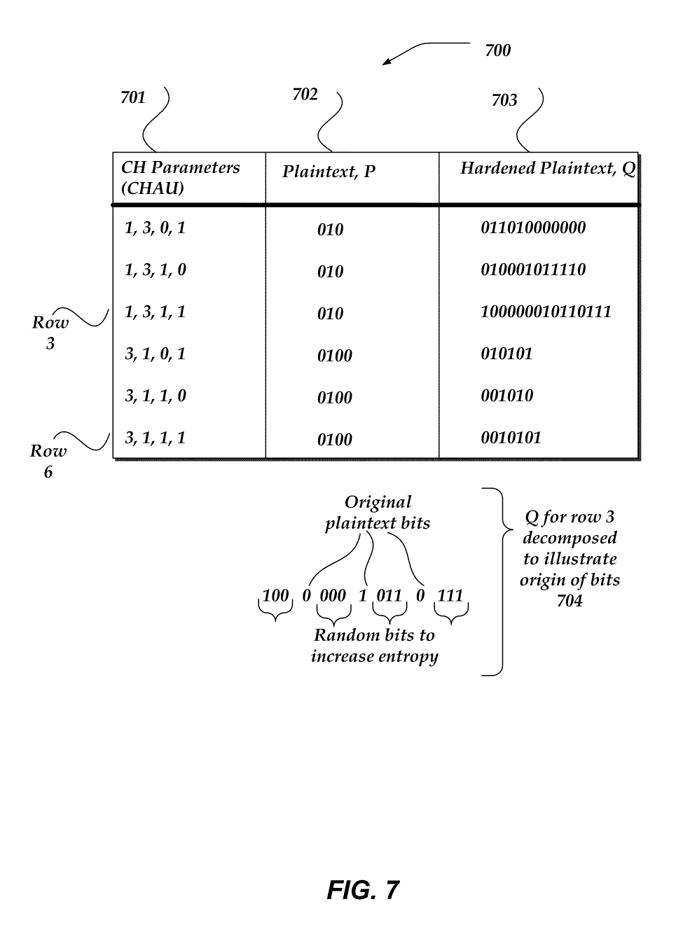

FIG. 7 illustrates one non-limiting, non-exhaustive example output using the process of FIG. 5. Shown in FIG. 7 is a table 700 of example values of CH parameters (column 701), example values of plaintext, P (column 702), and resulting hardened plaintext, Q (column 703). Other values may have been selected to illustrate hardening of plaintext as disclosed above; however, the examples shown are sufficient to provide an understanding of the above.

As an example, row 3 in table 700 indicates CH hardening parameters C, H, A, U, of 1, 3, 1, 1, respectively. That is, A and U indicate that starting and ending randomness is to be included, and C, the maximum length of contiguous untouched plaintext bits is one, and the minimum length of contiguous random bits are three. The plaintext, P, is represented for row 3 as the data string “010.” Also illustrated is a decomposition 704 of the resulting Q for row 3 showing the origin of the bits. As may quickly be seen, a relatively short plaintext data string may be readily obfuscated and lengthened.

The above specification, examples, and data provide a complete description of the composition, manufacture, and use of the invention. Since many embodiments of the invention can be made without departing from the spirit and scope of the invention, the invention resides in the claims hereinafter appended.

What is claimed as new and desired to be protected by Letters Patent of the United States is:

1. A computing device, comprising:
a non-transitory memory device configured to store data, and computer-executable instructions; and
a processor that is configured to employ the computer-executable instructions to perform actions, including:
receiving a sequence of bits as plaintext P;
initializing a hardening buffer with an empty bit string;
when hardening of the plaintext P is to start with randomness, appending H random bits to contents of hardening buffer;
while a length of a remaining portion of plaintext P is less than C, then:
appending C number of bits from plaintext P onto the contents of hardening buffer,
discarding C number of bits from plaintext P, and
appending H random bits to the contents of hardening buffer; and
when the length of remaining portion of plaintext P is greater or equal to C, appending the remaining bits from plaintext P to the contents of hardening buffer;
when hardening of the plaintext is to end with randomness, appending H random bit to the contents of hardening buffer; and
combining C and H with the contents of the hardening buffer.

2. The computing device of claim 1, wherein the processor is configured to perform actions, further including:
transmitting the combined C, H and contents of the hardening buffer over a network to a second computing device, wherein the second computing device employs the received C and H to retrieve the plaintext P from the hardening buffer.

3. The computing device of claim 1, wherein the processor is configured to perform actions, further including:
employing an encryption algorithm to encrypt the combined C, H, and contents of the hardening buffer.

4. The computing device of claim 1, wherein the determination of when hardening of the plaintext is to start with randomness or end with randomness, is a selectable option that is received by the computing device.

5. The computing device of claim 1, wherein combining C and H with the contents of the hardening buffer further comprises, placing C and H into a predefined order within header or trailer fields to the contents of the hardening buffer.

6. The computing device of claim 1, wherein the combined C, H and contents of the hardening buffer are encrypted and stored on a non-transitory storage device.

7. A computing system, comprising:
a non-transitory memory device; and
an hardening application stored on the memory device that when executed by at least one processor, performs actions, including:
receiving a sequence of bits as plaintext P;
initializing a hardening buffer with an empty bit string;
while a length of a remaining portion of plaintext P is less than C, then:
appending C number of bits from plaintext P onto the contents of hardening buffer,
discarding C number of bits from plaintext P, and
appending H random bits to the contents of hardening buffer; and
when the length of remaining portion of plaintext P is greater or equal to C, appending the remaining bits from plaintext P to the contents of hardening buffer; and
combining C and H with the contents of the hardening buffer.

8. The computing system of claim 7, wherein the hardening application performs actions, further including:
when hardening of the plaintext P is to start with randomness, prior to determining whether a length of the remaining portion of plaintext P is less than C, appending H random bits to contents of hardening buffer.

9. The computing system of claim 7, wherein the hardening application performs actions, further including:
when hardening of the plaintext is to end with randomness, appending H random bit to the contents of hardening buffer;

10. The computing system of claim 7, wherein at least one other application that when executed by the at least one processor, is configured to encrypted the combination of C, H, and the contents of the hardening buffer.

11. The computing system of claim 7, wherein the combination of C, H, and contents of the hardening buffer are encrypted and transmitted to another computing system within an email message.

12. The computing system of claim 7, wherein combining C and H with the contents of the hardening buffer using predefined separators configured to designate a separation between C, H, and the contents of the hardening buffer.

13. The computing system of claim 7, wherein C or H are defined as bit strings of a predefined length.

14. A computer based method, the method comprising:
transferring a combination of hardened plaintext and de-hardening parameters, C and H into a buffer;
clearing a plaintext buffer;
striping from the contents of the buffer the de-hardening parameters;
when it is determined that the hardened plaintext begins with randomness, discarding H number of bits from a starting position of the buffer;
when it is determined that the hardened plaintext ends with randomness, discarding H number of bits from an ending position of the buffer;
while a length of the contents of the buffer are greater than C:
appending C number of bits from the contents of the buffer to the plaintext buffer,
discarding C number of bits from the contents of the buffer, and
discarding H number of bits from the contents of the buffer; and
when it is determined that the length of the remaining contents of the buffer are greater than zero, appending a remaining number of bits from the contents of the buffer to the plaintext buffer, such that the plaintext buffer includes de-hardened plaintext.

15. The computer based method of claim 14, wherein the combination of hardened plaintext and de-hardening parameters are received as encrypted, and wherein prior to transferring the combination to the buffer, the combination is decrypted.

16. The computer based method of claim 14, wherein the combination of hardening plaintext and de-hardening parameters are combined using delineating parameters.

17. The computer based method of claim 14, wherein the combination of hardened plaintext and de-hardening parameters are combined such that the de-hardening parameters are one of appended to the hardening plaintext, or post-pended to the hardening plaintext in a predefined order.

18. The computer based method of claim 14, wherein the de-hardening parameters are configured to employ a pre-defined number of bits.

19. The computer based method of claim 14, wherein the determination that the hardened plaintext begins or ends with randomness is based on at least one additional de-hardening parameter that is included in the combination of hardened plaintext and de-hardening parameters.

20. The computer based method of claim 14, wherein the hardening plaintext includes content associated with an image.
